(19) United States
(12) Patent Application Publication
(10) Pub. No.: US 2006/0156629 A1
(43) Pub. Date: Jul. 20, 2006

(54) Window protection assembly

(76) Inventors: Mark R. Panka, Mosinee, WI (US); Emory M. Budzinski, Mosinee, WI (US); Edward L. Schield, Medford, WI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/331,538

(22) Filed: Jan. 13, 2006

Related U.S. Application Data
(60) Provisional application No. 60/643,670, filed on Jan. 13, 2005.

(51) Int. Cl. E05D 15/22

(52) U.S. Cl. 49/181

(57) ABSTRACT

A method for producing a window assembly that comprises providing a glass pane having an outer surface, and providing a plurality of frame assemblies that cooperate with one another to surround the glass pane. The method also includes covering at least a select one of the frame assemblies with at least one cover member having an outer surface. The method further includes covering at least a portion of the outer surface of the glass pane and at least a portion of the outer surface of the at least one cover member with a protective member such that the at least one cover member and the protective member are adapted to be removed from the window assembly subsequent to installation of the window assembly.

This application claims the benefit of U.S. Provisional Application No. 60/643,670, filed Jan. 13, 2005, entitled WINDOW PROTECTION ASSEMBLY, which is hereby incorporated herein by reference in its entirety.

### BACKGROUND OF THE INVENTION

The present invention relates generally to a method for protecting window assemblies, and in particular relates to a method for protecting the glass panes and frame assemblies of a window assembly prior and subsequent to installation of the window assembly into an associated building structure.

Window assemblies typically include an outer frame surrounding a plurality of window panes. The outer frame typically includes an aesthetic outer surface, while each window pane includes a viewable area of which needs to be free from viewing obstructions, such as scratches, and the like. Window assemblies are typically constructed offsite with respect to the building site, and are installed in an appropriate building structure as a single unit. Once installed, the window assembly is subject to the construction environment, and possible damage, including scratching, marring, etc., of the outer aesthetic surface of the frame assembly of the window panes.

Heretofore, the outer aesthetic surface of the outer frame and the surfaces of the window pane have been protected during shipping by various packaging arrangements and materials. However, these packaging arrangements and materials are removed prior to installation of the window within the building structure. Further, the outer surfaces of the associated glass panes have been protected by covering the glass panes with a protective film, however, these films protect only the glass pane, and are typically difficult to remove from the glass pane once the window assembly is installed within the building structure.

A window protection assembly is desired that protects an associated window assembly during shipping, installation of the window assembly into a building structure, and completion of the building structure subsequent to the installation of the window assembly therein. A window protection assembly is also desired that allows easy removal of such a protection assembly from an associated window assembly subsequent to the installation of the window assembly into the building structure.

### SUMMARY OF THE INVENTION

One aspect of the present invention is a method for producing a window assembly that comprises providing a glass pane having an outer surface, and providing a plurality of frame assemblies that cooperate with one another to surround the glass pane. The method also includes covering at least a select one of the frame assemblies with at least one cover member having an outer surface. The method further includes covering at least a portion of the outer surface of the glass pane and at least a portion of the outer surface of the at least one cover member with a protective member such that the at least one cover member and the protective member are adapted to be removed from the window assembly subsequent to installation of the window assembly.

Another aspect of the present invention is a method for producing a window assembly that includes providing a pair of glass panes each having an outer surface, providing an inner frame assembly, and providing a plurality of outer frame assemblies that cooperate with one another in the inner frame assembly to surround the pair of glass panes, such that the inner frame assembly is located between the pair of glass panes. The method also includes covering the outer frame assemblies and the inner frame assembly with at least one cover member having an outer surface. The method further includes covering at least a portion of the outer surface of each of the glass panes and at least a portion of the outer surface of the at least one cover member with a protective coating, such that the at least one cover member and the protective coating are adapted to be removed from the window assemblies subsequent to installation of the window assembly.

The present inventive window protection assembly protects an associated window assembly during shipping, installation of the window assembly into a building structure, and completion of the building structure subsequent to the installation of the window assembly therein. The window protection assembly further allows easy removal of such a protection assembly from an associated window assembly subsequent to the installation of the window assembly into the building structure and is particularly well adapted for the proposed use.

### BRIEF DESCRIPTION OF THE DRAWINGS

FIG. 1 is a perspective view of a window assembly and a window protection assembly embodying the present invention;

FIG. 2 is a cross-sectional view of a pair of side frame assemblies and a center frame assembly of the window assembly, taken along the line II-II, FIG. 1;

FIG. 3 is a cross-sectional view of a head jamb assembly and a sill assembly of the window assembly, taken along the line III-III, FIG. 1;

FIG. 4 is a perspective view of a side jamb cover;

FIG. 5 is an end view of the side jamb cover;

FIG. 6 is a perspective view of a head jamb or sill cover;

FIG. 7 is an end view of the head jamb or sill cover; and

FIG. 8 is an end view of a mull cover.

### DETAILED DESCRIPTION OF THE PREFERRED EMBODIMENTS

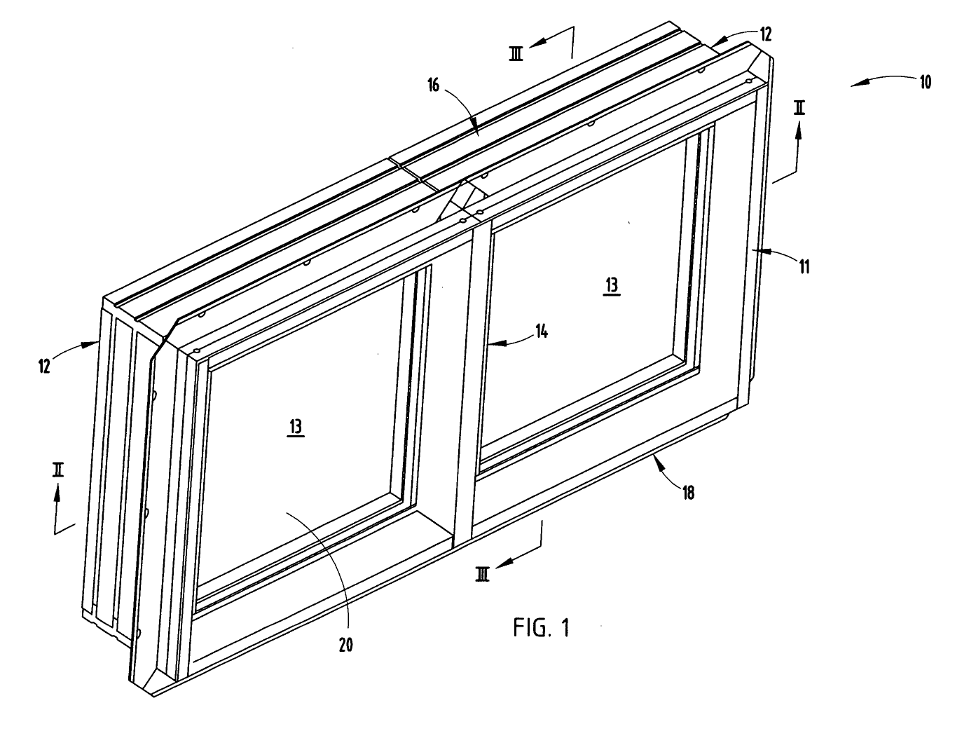

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

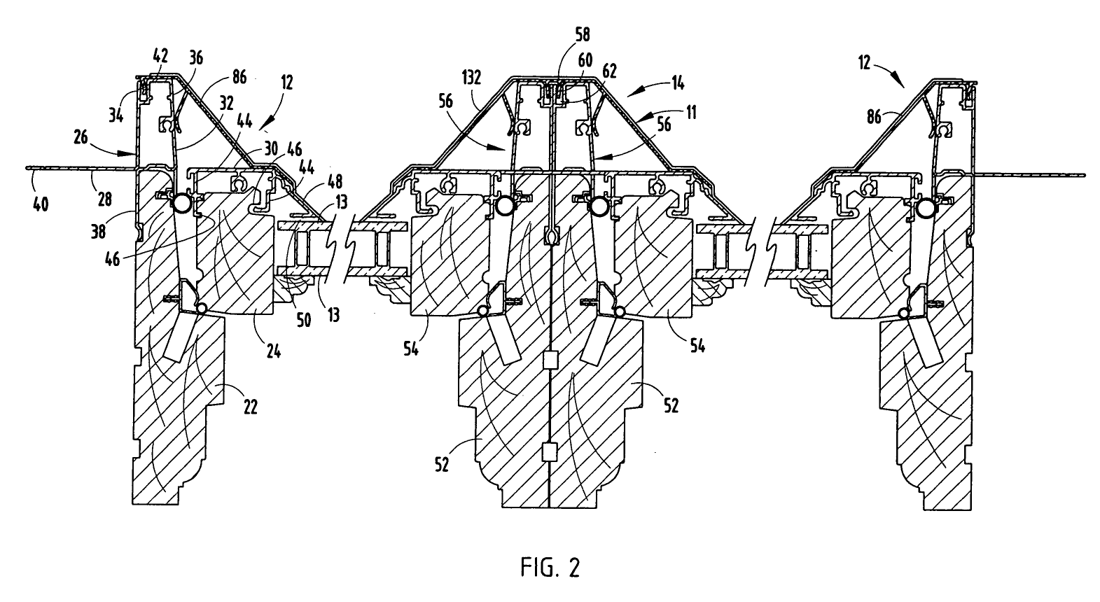

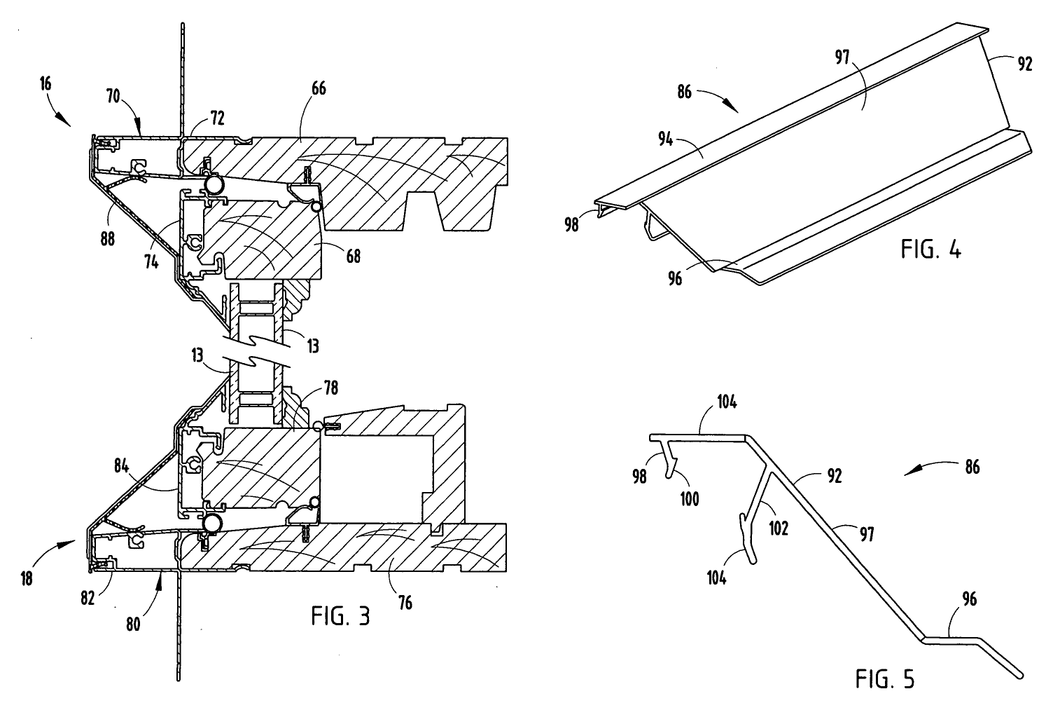

The reference numeral 10 (FIG. 1) generally designates a window assembly that includes a window protection assembly 11 embodying the present invention. The window assembly 10 includes side frame assemblies 12 (FIG. 2), a center frame or mull assembly 14, a top frame assembly 16 (FIG. 3), a bottom frame assembly 18, and window panes 13. The window protection assembly 11 covers an outer surface of the frame assemblies 12, 14, 16, 18, and an outer surface 20 of the window panes 13, as described below.

Each side frame assembly 12 includes a side jamb 22 and a side frame member 24, each preferably constructed of wood, and adapted for relative movement therebetween, as is known in the art. Each side frame assembly 12 further includes a side frame cladding 26 having a first portion 28 that covers the side jamb 22 and a separate second portion 30 that covers the side frame member 24. The first portion 28 includes an outwardly-extending rectangularly-shaped body portion 32 having an outwardly-disposed coupling channel 34 and an inwardly-facing abutment wall 36. The first portion 28 also includes a C-shaped engagement portion 38 that engages the side jamb 22, and an alignment leg 40 extending laterally therefrom and that is adapted to abut a portion of a building structure, thereby allowing proper alignment of the window assembly 10 with the building structure. The coupling channel 34 includes a plurality of engagement teeth 42 extending longitudinally therealong. The second portion 30 is C-shaped and includes a pair of legs 44 that engage a pair of channels 46 of the side frame member 24, thereby securing the second portion 30 of the frame cladding 26 with the side frame member 24. The second portion 30 further includes an inwardly-extending V-shaped leg 48 adapted to provide a gap 50 between the leg 48 and one of the window panes 13 within which a sealant is located.

The center frame or mull assembly 14 is similar in construction to the side frame assemblies 12 in that the center frame assembly 14 includes a pair of assemblies similar to the side frame assemblies 12 oriented in a back-to-back relationship. Specifically, the center frame assembly 14 includes a pair of jambs 52 similar to side jambs 22, a pair of frame members 54 similar to the side frame members 24, and a pair of frame claddings 56 similar to the side frame claddings 26. A center clip 58 includes a pair of engagement legs 60 that engage the coupling channel 62 of each frame cladding 56.

The top frame assembly 16 includes a head jamb 66 that aligns along the top of the window assembly 10. The top frame assembly 16 further includes a top frame member 68, a top frame cladding 70 having a first portion 72 and a second portion 74, each constructed similarly to the side frame member 24, the side frame cladding 26 and the first and second portions 28, 30, respectively. The bottom frame assembly 18 includes a sill 76 that aligns along the bottom of the window assembly 10. The bottom frame assembly 18 further includes a bottom frame member 78, a bottom frame cladding 80 having a first portion 82 and a second portion 84, each constructed similarly to the side frame member 24, the side frame cladding 26 and the first and second portions 28, 30, respectively.

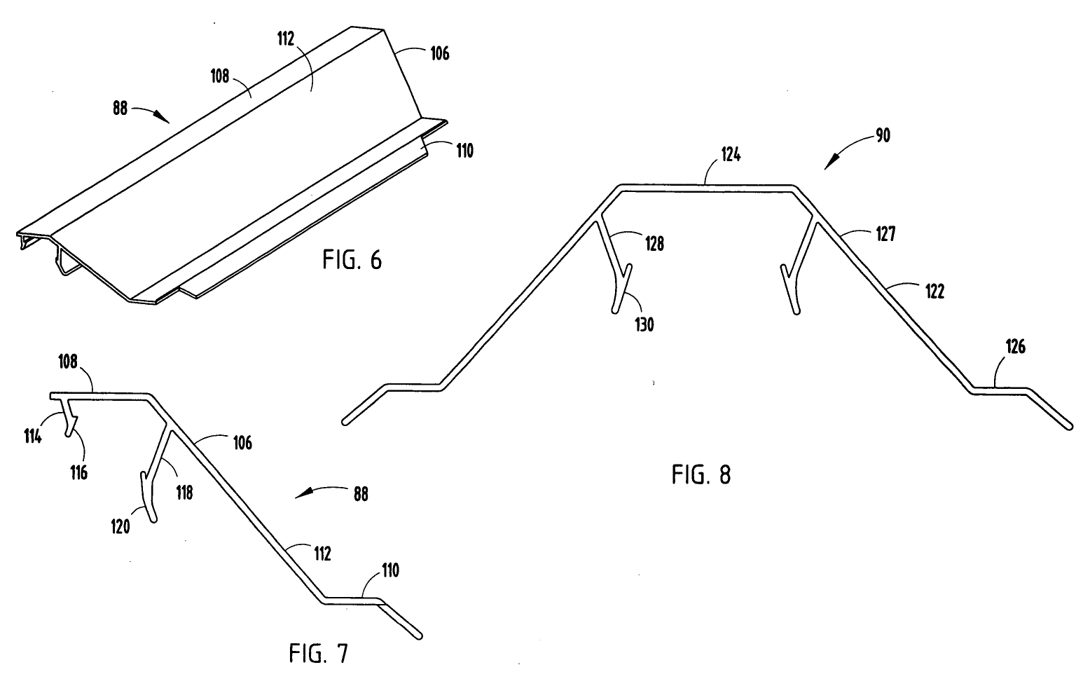

The window protection assembly 11 includes a pair of side jamb covers 86 (FIGS. 4 and 5), a pair of head jamb covers and sill covers 88 (FIGS. 6 and 7), and a mull cover 90. Each side jamb cover 86 includes an angled body portion 92, a top lip portion 94 extending outwardly from the body portion 92, and a bottom lip portion 96 extending inwardly from the body portion 92. The body portion 92, the top lip portion 94 and the bottom lip portion 96 cooperate to form an outer surface 97. Each side jamb cover 86 further includes a flexibly-resilient first engagement arm 98 extending inwardly from the top lip portion 94 and including a barbed end 100. Each side jamb cover 86 further includes a second engagement arm 102 extending inwardly from the body portion 92 and including a barbed end 104. Each of the sill covers and head jamb covers 88 are similar in construction to the side jamb covers 86, with the major exception being the configuration of the associated lower lip of each. Each of the sill covers and head jamb covers 88 include a body portion 106, a top lip portion 108 and a bottom lip portion 110 that cooperate to form an outer surface 112. Each sill cover and head jamb cover 88 further includes a first engagement arm 114 extending inwardly from the top lip portion 108 and including a barbed end 116, and a second engagement arm 118 extending inwardly from the body portion 106 and including a barbed end 120. The mull cover 90 includes a pair of angular sidewalls 122, a top wall 124 extending between and connecting the sidewalls 122 and a pair of bottom lip portions 126 extending outwardly from each of the sidewalls 122. The sidewalls 122, the top wall 124 and the bottom lip portions cooperate to form an outer surface 127. The mull cover 90 further includes a pair of abutment legs 128 extending inwardly from the sidewalls 122 and each including a barbed end 130. Preferably, each of the barbed ends 100, 104, 116, 120, 130 are constructed of a flexibly resilient material, such as Santoprene™, as available from Advanced Elastomer Systems of Akron, Ohio however, other materials suitable for such application may be utilized therefore. Moreover, the entire construction of each of the side jamb covers 86, the sill and head jamb covers 88, and the mull cover 90 may be made from a flexibly-resilient material.

In assembly, the window panes 13, the side frame assemblies 12, the center frame assembly 14, the top frame assembly 16 and the bottom frame assembly 18 are coupled in a manner that is known in the art to form the window assembly 10. Subsequent to assembly of the window assembly 10, the side jamb covers 86, the sill covers and head jamb covers 88, and the mull cover 90 are coupled with the window assembly 10. Specifically, each of the side jamb covers 86 are coupled with the window assembly 10 such that each of the side jamb covers 86 covers a respective side frame assembly 12. Each of the side jamb covers 86 are coupled to a respective side frame assembly 12 by inserting the first engagement arm 98 of the side jamb cover 86 into the coupling channel 34 of the first portion 28 of the side frame cladding 26 such that the barbed end 100 of the first engagement arm 98 engages the teeth 42 of the coupling channel 34, and the end 104 of the second engagement arm 102 frictionally engages the body portion of the first portion 28 of the side frame cladding 26. The sill cover and head jamb cover 88 are coupled with the top frame assembly 16 and the bottom frame assembly 18 in a like manner. The mull cover 90 is coupled with the center frame assembly 14 by pressing the mull cover 90 inwardly such that each end 130 of the abutment legs 128 of the mull cover 90 frictionally engage the body portion of the first portion of the frame cladding 56.

The window protection assembly 11 is then completed by spraying a thin protective film 132 over the window assembly 10, such that the protective film 132 covers and adheres to the outer surface 97 of the side jamb covers 86, the outer surface 112 of each of the sill covers and head jamb covers 88, the outer surface 127 of the cover 90, and the outer surface 20 of the window panes 13. The protective film 132 is preferably sprayed upon the outer surfaces 97, 112, 127 as described above by an automated system incorporated within a production line, but may also be applied to the outer surfaces 97, 112, 127 by hand. The protective film 132 is preferably constructed of water-based polymer, for example Temprotec™, as available from Tempro Tec, Inc. of Canada, however, other suitable materials may be utilized. Alternatively, the protective film 132 is applied via a roll-on type method, or is supplied in a roll sheet form which is applied to the assembly.

Subsequent to the assembly of the window assembly 10 and the window protection assembly 11, the window assembly 10 is packaged for delivery to a building construction site where the window assembly 10 is placed into the building structure with the window protection assembly 11 still coupled with the window assembly 10. Subsequent to installation, the window protection assembly 11 is removed from the window assembly 10 by grasping each of the covers 86, 88, 90, unsnapping the covers 86, 88, 90 from the frame assemblies 12, 14, 16, 18, and peeling the protective film 132 from the outer surface 20 of each window pane 13.

In the foregoing description, it will be readily appreciated by those skilled in the art that modifications may be made to the invention without departing from the concepts disclosed herein. Such modifications are to be considered as included in the following claims, unless these claims by their language expressly state otherwise. Accordingly, the scope of the present invention should be considered in terms of the following claims and is understood not to be limited to the details of structure and operation shown and described in the specification and drawings.

1. A method for producing a window assembly comprising:
providing a glass pane having an outer surface;
providing a plurality of frame assemblies that cooperate with one another to surround the glass pane;
covering at least a select one of the frame assemblies with at least one cover member having an outer surface; and
covering at least a portion of the outer surface of the glass pane and at least a portion of the outer surface of the at least one cover member with a protective member such that the at least one cover member and the protective member are adapted to be removed from the window assembly subsequent to installation of the window assembly.

2. The method of claim 1, wherein the step of covering the outer surfaces of the glass pane and the cover member with a protective member includes covering at least a portion of outer surface of the glass pane and at least a portion of the outer surface of the at least one cover member with a thin membrane.

3. The method of claim 2, wherein the covering step includes spraying the thin membrane onto at least a portion of the outer surface of the glass pane and at least a portion of the outer surface of the at least one cover member.

4. The method of claim 3, wherein the covering step includes covering each frame assembly with a cover member.

5. The method of claim 4, wherein the step of covering the frame assemblies with the cover members includes snappably engaging the cover members with the frame assemblies.

6. The method of claim 1, wherein the covering step includes spraying the protective member onto at least a portion of the outer surface of the glass pane and at least a portion of the outer surface of the at least one cover member.

7. The method of claim 1, wherein the covering step includes covering each of the frame assemblies with a cover member.

8. The method of claim 1, wherein the covering step includes covering at least a portion of the outer surface of the glass pane with the protective coating such that the protective coating contacts the glass pane.

9. The method of claim 1, wherein the step of providing the plurality of frame assemblies includes providing a plurality of frame members and a plurality of frame claddings covering the frame members.

10. The method of claim 9, wherein the step of covering the at least one frame member with at least one cover member includes snappably engaging the plurality of cover members with the plurality of frame claddings.

11. The method of claim 1, wherein the covering step includes providing the protective member as a single integrally formed piece.

12. The method of claim 1, wherein the step of covering the frame assemblies includes providing at least one flexibly resilient cover member.

13. The method of claim 1, wherein the step of covering the outer surfaces of the glass pane and the at least one cover member includes adhering the protective member to the outer surfaces of the glass pane and the at least one cover member.

14. A method for producing a window assembly, comprising:
providing a pair of glass panes each having an outer surface;
providing an inner frame assembly;
providing a plurality of outer frame assemblies that cooperate with one another and the inner frame assembly to surround the pair of glass panes, such that the inner frame assembly is located between the pair of glass panes;
covering the outer frame assemblies and inner frame assembly with at least one cover member having an outer surface; and
covering at least a portion of the outer surface of each of the glass panes and at least a portion of the outer surface of the at least one cover member with a protective coating, such that the at least one cover member and the protective coating are adapted to be removed from the window assembly subsequent to installation of the window assembly.

15. The method of claim 14, wherein the covering step includes spraying the protective coating onto at least a portion of the outer surface of each of the glass panes and at least a portion of the outer surface of the at least one cover member.

16. The method of claim 15, wherein the step of covering the outer frame assemblies with the at least one cover member includes snappably engaging the at least one cover member with the outer frame assemblies.

17. The method of claim 16, wherein the step of covering the inner frame assemblies with the at least one cover member includes frictionally engaging the at least one cover member with the inner frame assembly.

18. The method of claim 14, wherein the step of providing the plurality of outer frame assemblies includes providing a plurality of outer frame members and a plurality of outer frame claddings covering the outer frame members, and the step of providing the inner frame assembly includes providing an inner frame member and an inner frame cladding covering the inner frame member.

19. The method of claim 18, wherein the step of covering the plurality of outer frame assemblies with the at least one cover member includes snappably engaging a plurality of cover members with the outer frame claddings.

20. The method of claims 19, wherein the step of covering the inner frame assembly with the at least one cover member includes frictionally engaging the at least one cover member with the inner frame cladding.

21. The method of claim 14, wherein the step of covering the outer frame assemblies with the at least one cover member includes snappably engaging the at least one cover member with the outer frame assemblies.

22. The method of claim 14, wherein the step of covering the inner frame assembly with the at least one cover member includes frictionally engaging the at least one cover member with the inner frame assembly.

23. The method of claim 14, wherein the covering step includes providing the protective coating as a single integrally formed piece.

24. The method of claim 14, wherein the step of covering the frame assemblies includes providing at least one flexibly resilient cover member.

25. The method of claim 14, wherein the cover step includes adhering the protective coating to the outer surfaces of the glass panes and the at least one cover member.

26. The method of claim 14, wherein the covering step includes covering at least a portion of the glass panes with the protective coating such that the protective coating contacts the glass panes.
